(19) United States
(12) Patent Application Publication
(10) Pub. No.: US 2007/0035598 A1
(43) Pub. Date: Feb. 15, 2007

(54) INKJET INK COMPOSITION, INKJET CARTRIDGE INCLUDING THE SAME, AND INKJET RECORDING APPARATUS INCLUDING THE INKJET CARTRIDGE

(76) Inventors: Seung-min RYU, Yongin-si (KR); Yeon-kyoung Jung, Suwon-si (KR)

Correspondence Address: STANZIONE & KIM, LLP, 919 18TH STREET, N.W., SUITE 440, WASHINGTON, DC, 20006, US

(21) Appl. No.: 11/463,945

(22) Filed: Aug. 11, 2006

(30) Foreign Application Priority Data
Aug. 13, 2005 (KR) 2005-74565

(51) Int. Cl. G01D 11/00; C09D 11/02

(52) U.S. Cl. 347/100; 106/31.27; 106/31.6; 106/31.58; 106/31.86; 106/31.47; 106/31.77; 106/31.43; 106/31.75

(57) ABSTRACT

An inkjet ink composition, an inkjet printer cartridge including the ink composition and an inkjet recording apparatus including the ink cartridge including the ink composition, the inkjet ink composition including a colorant, water, and an additive, the additive including at least one media-philic additive in an amount in a range of about 0.1 to about 35 parts by weight based on 100 parts by weight of the ink composition, and an amount of the media-phobic additive is in a range of about 1 to about 25 parts by weight based on 100 parts by weight of the ink composition.

### CROSS-REFERENCE TO RELATED APPLICATIONS

This application claims priority under 35 U.S.C. §119(a) from Korean Patent Application No. 10-2005-0074565, filed on Aug. 13, 2005, in the Korean Intellectual Property Office, the disclosure of which is incorporated herein in its entirety by reference.

### BACKGROUND OF THE INVENTION

1. Field of the Invention

The present general inventive concept relates to an ink composition, and more particularly, to an inkjet ink composition having an optimal compatibility with a surface property of a printing medium used in a high speed-and-quality printing system.

2. Description of the Related Art

A penetration characteristic of an ink composition to penetrate a printing medium is generally related to an interface interaction between a surface of the printing medium and the ink composition that reaches the printing medium. The penetration characteristic can be expressed as a contact angle of the ink composition with respect to the surface of the printing medium.

U.S. Pat. No. 6,095,645 discloses that a contact angle of a dye ink becomes 0° after 1 second in the case of a printing medium including an ink-repellent layer made of a water soluble silicon compound or a fluorine compound, and U.S. Pat. No. 6,572,227 discloses that a contact angle of a self-dispersible pigment ink is about 60° or less after 1 second from dropping 4 μl of the self-dispersible pigment ink.

Further, U.S. Pat. No. 5,849,815 discloses a dye ink composition that has a surface tension of 26×10-⁵ N/cm to 40×10-⁵ N/cm, includes a polymer, and has a contact angle of 60 to 180°. U.S. Pat. No. 6,811,251 discloses an ink set including a pigment ink and a dye ink having an improved contact angle. According to U.S. Pat. No. 6,811,251, only when the difference of the contact angle 1 second after the dye ink reaches a printing medium is −70 to −10°, and −15 to 0° for the pigment ink, blurring of each ink is excellent, spreading between the inks is good, and the inks are excellently dried.

As mentioned above, an initial contact angle of a conventional dye ink should generally be higher than 40°, and that of a conventional pigment ink should generally be higher than 60°. This is because of the following reasons.

In prior art inkjet printing systems, since a printing speed is low and a black pigment ink having large droplets should generate a sufficient image concentration during single printing, most inks must remain on a printing medium for a long time, and thus penetration of ink into the printing medium must be minimized. Accordingly, an initial contact angle of the pigment ink should generally be higher than 60°, and only a predetermined amount of ink must penetrate under the printing medium after 1 second.

Meanwhile, in the case of color dye inks, printing is generally performed several times to display various images having high color concentration. Accordingly, bleeding between colors occurs severely due to a long period of time during which the dye inks remain on a printing medium. Therefore, the initial contact angle of a color dye ink is less than 40°, unlike that of a pigment ink.

Even though prior art inks having a proper initial contact angle are used in a high speed-and-quality printing system, bleeding between colors cannot still be optimized easily. Particularly, in the case of a pigment ink having a high contact angle, a printed image is too slowly dried to prevent back-smear on a next printed paper or the hand of a user.

### SUMMARY OF THE INVENTION

The present general inventive concept provides an inkjet ink composition, the inkjet ink composition having an optimal compatibility with a surface property of a printing medium used in a high speed-and-quality printing system in order to maintain an absorption time of a dye ink and a pigment ink within 1 second, to obtain a high color concentration without affecting image quality due to excessive penetration of ink, and to minimize bleeding between colors to prevent a back-smear, an inkjet cartridge including the same, and an inkjet recording apparatus including the inkjet cartridge.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing an inkjet ink composition having optimal compatibility with a surface property of a printing medium, including a colorant, water, and a media-philic additive having an affinity to the printing medium, in which an amount of the media-philic additive is in a range of about 0.1 to about 35 parts by weight based on 100 parts by weight of the inkjet ink composition.

The inkjet ink composition may further include a media-phobic additive having substantially no affinity to the hydrophilic printing medium, in which an amount of the media-phobic additive is in a range of about 1 to about 12,500 parts by weight based on 100 parts by weight of the media-philic additive.

The foregoing and/or other aspects and utilities of the present general inventive concept may also be achieved by providing an inkjet printer cartridge including the ink composition.

The foregoing and/or other aspects and utilities of the present general inventive concept may also be achieved by providing an inkjet recording apparatus including the ink cartridge including the ink composition.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an inkjet recording apparatus having an ink cartridge including an ink composition according to an embodiment of the present general inventive concept; and

FIG. 2 is a sectional view illustrating an ink cartridge including an ink composition according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An inkjet ink composition according to embodiments of the present general inventive concept includes a colorant, a liquid vehicle (e.g., water), and an additive, and a material and an amount of the additive are controlled to be in a desirable range according to a property of a printing medium on which the ink composition is to be printed.

A hydrophilic media according to an embodiment of the present general inventive concept may be a general paper including mainly pulp, a coating paper or a photo paper coated with a water coating solution, a fiber coated with an aqueous coating solution or processed with a hydrophilic treatment, or plastic, metal media, and the like. A hydrophobic media according to an embodiment of the present general inventive concept may be a substrate made of glass or silicon, a coating paper or a photo paper coated with a coating solution including oil or wax and a hydrophobic organic solvent, or processed with a hydrophobic treatment, textile, plastic, or metal media, and the like. However, the media according to the present invention is not limited to the above examples and embodiments.

Furthermore, the ink additive may include at least one media-philic additive. An amount of the media-philic additive may be in a range of about 0.1 to about 35 parts by weight based on 100 parts by weight of the inkjet ink composition.

If the amount of the media-philic additive is less than about 0.1 parts by weight, an affinity of the ink composition to the printing medium is very low so that an absorption time of the ink composition becomes long, thereby causing a back smear. If the amount of the media-philic additive is higher than about 35 parts by weight, the affinity of the ink composition to the printing medium is very high so that the ink composition penetrates the printing media too much, thereby causing a low color concentration.

The additive may further include a media-phobic additive having substantially no affinity to the printing medium. An amount of the media-phobic additive in the ink composition may be in a range of about 0.1 to about 25 parts by weight based on 100 parts by weight of the inkjet ink composition. The amount of the media-phobic additive may be in a range of about 1 to about 12,500 parts by weight based on 100 parts by weight of the media-philic additive. For example, the amount of the media-phobic additive in the ink composition may be in the range of about 1 to about 6,250 parts by weight based on 100 parts by weight of the media-philic additive, about 6,250 to about 12,500 parts by weight based on 100 parts by weight of the media-philic additive, and about 3,000 to about 9,000 parts by weight based on 100 parts by weight of the media-philic additive.

When the inkjet ink composition includes the hydrophobic media, the amount of the media-phobic additive may be in a range of about 1 to about 1000 parts by weight based on 100 parts by weight of the media-philic additive. This is because in the inkjet ink composition used to print on the hydrophobic media, an influence of the media-phobic additive to an affinity change of the media is much higher than when the inkjet ink composition used to print on the hydrophilic media. In the inkjet ink composition used to print on the hydrophilic media, if the amount of the media-phobic additive is higher than about 12,500 parts by weight compared to the amount of the media-philic additive in the inkjet ink composition used to print on the hydrophobic media (or if the amount of the media-phobic additive is higher than 1000 parts by weight), a proportion of the media-phobic additive to the media-philic additive becomes too high, and thus the affinity of the ink composition to the printing medium may become too low. If the amount of media-phobic additive is less than about 1 part by weight, an effect thereof may be undesirably small. Further, if the amount of the media-phobic additive is higher than about 25 parts by weight based on 100 parts by weight of the inkjet ink composition, the amount of the media-phobic additive in the inkjet ink composition highly increases, so that the affinity of the inkjet ink composition used to print on the hydrophobic media may become low, and if the amount of the media-phobic additive is less than about 0.1 parts by weight based on 100 parts by weight of the ink composition, an effect thereof may be undesirably small.

When hydrophilic printing media are used, the ink composition may include a colorant, a liquid vehicle (e.g., water), and a media-philic additive having an affinity to the hydrophilic printing media, and an amount of the media-philic additive in the ink composition may be in a range of about 0.1 to about 35 by weight based on 100 parts by weight of the inkjet ink composition.

When hydrophobic printing media are used, the ink composition may include a colorant, a liquid vehicle (e.g., water), and a media-philic additive having an affinity to the hydrophobic printing media, and an amount of the media-philic additive in the ink composition may be in a range of about 0.1 to about 35 parts by weight based on 100 parts by weight of the inkjet ink composition.

The term “media-philic additive” refers to an organic solvent having an initial contact angle of 50° or less for 10% by weight of aqueous solution on a printing medium, or a surfactant having an initial contact angle of 50° or less for 1% by weight of aqueous solution on a printing medium.

The term “media-phobic additive” refers to an organic solvent having an initial contact angle of 50° or higher, particularly 60° or higher, for 10% by weight of aqueous solution on a printing medium, or a surfactant having an initial contact angle of 50° or higher, particularly 60° or higher, for 1% by weight of aqueous solution on a printing medium.

The term “initial contact angle” refers to an angle formed at an interface between a solution and a printing medium, measured with a contact angle measuring equipment FTA 200 (manufactured by First Ten Angstrom Company) after 0.5 seconds from dropping one droplet of the solution onto the printing medium using a syringe having a gauge 22 needle.

Table 1 describes specific examples of media-philic additives and media-phobic additives in solutions that can be used in ink compositions according to embodiments of the present general inventive concept, and an affinity to media based on the initial contact angles of these solutions as described above when used in the ink compositions to print on general paper as hydrophilic printing media, but the present general inventive concept is not limited to these examples.

TABLE 1

| | | Affinity | |
|---|---|---|---|
| | Component | PI | PO |
| Glycol | EG* (10%) | | ◯ |
| | DEG* (10%) | | ◯ |
| | PEG 200* (10%) | | ◯ |
| | PEG 600* (10%) | | ◯ |
| Diol, triol | 1,4-butanediol* (10%) | | ◯ |
| | 1,5-pentanediol* (10%) | | ◯ |
| | 1,2-hexanediol* (10%) | ◯ | |
| | 1,6-hexanediol* (10%) | | ◯ |
| | Ethriol* (10%) | | ◯ |
| | Glycerine* (10%) | | ◯ |
| Cyclic amide | Succinimide* (10%) | | ◯ |
| | Caprolactam* (10%) | | ◯ |
| | 2-pyrrolidone* (10%) | | ◯ |
| | 2-cyclohexyl-2-pyrrolidone* (10%) | ◯ | |
| Ether | DEG-MBE* (10%) | ◯ | |
| | TEG-MBE* (10%) | ◯ | |
| Ketone | Methylethyl ketone** (10%) | | ◯ |
| Wax | Polyethylene wax** (10%) | | ◯ |
| | Stearyl stearamide wax** (10%) | | ◯ |
| Oil | Dimetylpolysiolxane** (10%) | | ◯ |
| | Hexane** (10%) | | ◯ |
| | Norpar** (10%) | | ◯ |
| Surfactant | Surfynol 465* (1%) (Air Products and | ◯ | |
| | Chemicals, Inc) | | |
| | BYK 181* (1%) (BYK-Chemie Company) | | ◯ |
| | Polyethyleneglycol sorbitan monolaurate* | | ◯ |
| | (1%) | | |

In Table 1, the asterisk “*” indicates an amount % in an aqueous solution, the double asterisk “**” indicates an amount % in an alcohol, PI is media-philic, and PO is media-phobic. Furthermore, EG is ethylene glycol, DEG is diethylene glycol, PEG is polyethylene glycol, DEG-MBE is diethylene glycol monobutyl ether, and TEG-MBE means triethylene glycol monobutyl ether.

As discussed above, the “media-phobic additives” described in Table 1 are media-phobic to hydrophilic printing media, and the “media-philic additives” described in Table 1 are media-philic to hydrophilic printing media. However, when ink compositions according to embodiments of the present general inventive concept are used to print on a hydrophobic printing medium, the compounds categorized as media-phobic additives in Table 1 are used as media-philic additives, and the compounds categorized as media-philic additives in Table 1 are used as media-phobic additives.

An amount of water in the ink composition according to embodiments of the present general inventive concept is in a range of about 10 to about 90 parts by weight based on 100 parts by weight of the ink composition. If the amount of the liquid vehicle (e.g., water) is less than about 10 parts by weight, a viscosity of the ink composition becomes too high, and the ink composition cannot be ejected. If the amount of the liquid vehicle (e.g., water) is higher than about 90 parts by weight, a colorant concentration of the ink composition becomes too low, thereby lowering image quality.

The colorant used in the ink composition according to embodiments of the present general inventive concept is not particularly limited. For example, a dye that is soluble or dispersible in water, a pigment that is used together with a dispersant and is stably dispersible in water, a self-dispersible pigment that is stably dispersible in water without a separate dispersant, or mixtures thereof can be used as the colorant.

Specific examples of the dye include, but are not limited to, Food Black dye, Food red dye, Food Yellow dye, Food Blue dye, Acid Black dye, Acid Red dye, Acid Blue dye, Acid Yellow dye, Direct Black dye, Direct Blue dye, Direct Yellow dye, anthraquinone dye, monoazo dye, disazo dye, and phthalocyanine derivatives. Specific examples of the pigment include, but are not limited to, carbon black, graphite, vitreous carbon, activated charcoal, activated carbon, anthraquinone, phthalocyanine blue, phthalocyanine green, diazos, monoazos, pyranthrones, perylene, quinacridone, and indigoid pigments. Specific examples of the self-dispersible pigment include, but are not limited to, cabojet-series or CW-series available from Orient Chemical.

An amount of colorant in the inkjet ink composition according to an embodiment of the present general inventive concept may be in a range of about 0.1 to about 10 parts by weight based on 100 parts by weight of the inkjet ink composition. When the amount of the colorant is less than about 0.1 parts by weight, an image concentration is undesirably low. When the amount of the colorant is higher than about 10 parts by weight, an ink viscosity becomes too high, and easy ejection of ink droplets becomes difficult.

In addition, the ink composition according to embodiments of the present general inventive concept can further include at least one of a humectant, a dispersant, a viscosity controller, a pH controller, an anti-oxidant, and the like, if desired.

The ink composition according to embodiments of the present general inventive concept can be used in a high speed-and-resolution inkjet printing system. In such a high speed-and-resolution inkjet printing system, bleeding between colors is minimized in order to display a clear image, a time of absorption of penetrated ink is shortened below 1 second when 1 μL of an ink drop is dropped on a medium, and a decrease of a color concentration of the image due to ink penetration is prevented to maintain a sufficient optical density, even on a general paper. When a single pass printing is performed with 7 ρL of droplets at 600 dpi, 100% solid color concentration of a black ink can be maintained at an optical density higher than or equal to 1.05, and that of a color ink can be maintained at an optical density higher than or equal to 0.8.

The ink composition according to embodiments of the present general inventive concept may have an initial contact angle of about 30 to about 65°, an absorption time within 1 second at 1 μL of an ink drop, and an optical density higher than or equal to 1.05, when a pigment is used as the colorant in the ink composition.

The ink composition according to other embodiments of the present general inventive concept may have an initial contact angle of about 25 to about 45°, an absorption time within 1 second at 1 μL of an ink drop, and an optical density higher than or equal to 0.8, when a dye is used as the colorant in the ink composition.

Ink compositions according to embodiments of the present general inventive concept can be used in combination with other inks or separately in an inkjet printer to print various colors.

Ink compositions according to embodiments of the present general inventive concept can be supplied via an ink receiving part of an inkjet recording apparatus or an inkjet printer cartridge. An inkjet recording apparatus according to an embodiment of the present general inventive concept can include, for example, a thermal head that ejects ink droplets by vapor pressure by heating an ink composition, a piezoelectric head that ejects ink droplets using a piezoelectric device, a disposable head, or a permanent head. Further, the inkjet recording apparatus can be a scanning type printer or an array type printer, and used for desktop computers, textile industry uses, and other industry uses. The head type, the printer type, and the uses thereof are mentioned for illustrative purposes only.

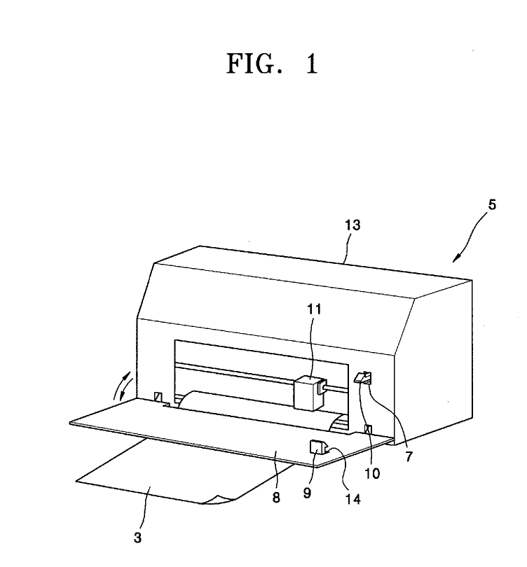

FIG. 1 illustrates an inkjet recording apparatus 5 according to an embodiment of the present general inventive concept.

Referring to FIG. 1, the inkjet recording apparatus 5 according to this embodiment of the present general inventive concept includes an ink cartridge 11 having an ink composition including a chromophore-containing colorant and a colorant-like additive. A cover 8 is connected, for example through a hinge (not illustrated), with a main body 13 of the inkjet recording apparatus 5. A portion of a moving latch 10 protrudes through a hole 7. The moving latch 10 to be engaged with a fixed latch 9, and the fixed latch 9 is connectable to the inside of the cover 8 when the cover 8 is closed. The cover 8 has a recess 14 corresponding to the region of the moving latch 10 protruding through the hole 7. The inkjet printer cartridge 11 is mounted in the main body 13 and ink is ejected on a piece of medium (e.g., paper) 3 passing through a lower part of the inkjet printer cartridge 11.

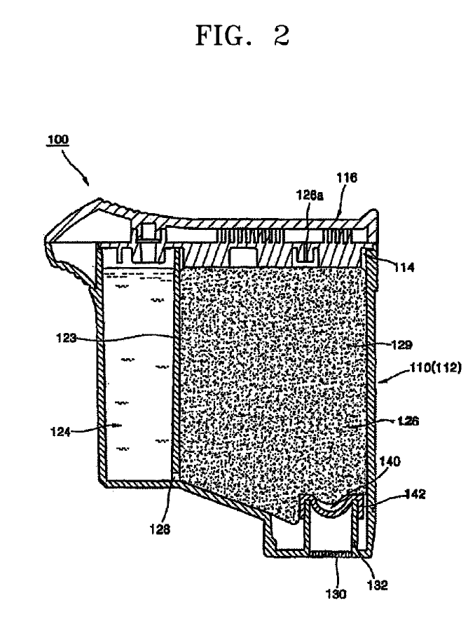

FIG. 2 is a sectional view illustrating an inkjet printer cartridge 100 including an ink composition according to an embodiment of the present general inventive concept. The inkjet printer cartridge 100 includes a main body 110 forming an ink receiver 112, an inner cover 114 covering a top region of the ink receiver 112, and an outer cover 116 spaced apart from the inner cover 114 at a predetermined interval to seal the ink receiver 112 and the inner cover 114.

The ink receiver 112 is divided into a first chamber 124 and a second chamber 126 by a vertical barrier wall 123. An ink passage 128 is formed in a lower area of the vertical barrier wall 123 between the first chamber 124 and the second chamber 126. Ink is filled into the first chamber 124, and then a sponge 129 within the second chamber 126. Avent hole 126a corresponding to the second chamber 126 is formed in the inner cover 114.

A filter 140 to prevent an ejection hole 130 of a printer head from clogging is formed in a lower part of the second chamber 126 to filter impurities and minute bubbles in the ink. A hook 142 is formed in an edge region of the filter 140 and coupled to a top region of a standpipe 132. The ink in the ink receiver 112 passes through the ejection hole 130 of the printer head and is ejected in small droplets onto a printing medium.

The present general inventive concept will be described in greater detail with reference to the following example (Table 2) of ink compositions used to print on a hydrophilic printing medium that has a high compatibility with water, and the following example (Table 3) of ink compositions used to print on a hydrophobic medium that has a low compatibility with water. The following examples are for illustrative purposes only and are not intended to limit the scope of the general inventive concept.

Ink compositions according to embodiments of the present general inventive concept are prepared as follows.

### EXAMPLES

Components described for each ink composition of Examples 1-14 and Comparative Examples 1-12 in Table 2 and Table 3 are mixed, and a humectant, a dispersant, a viscosity controller, and an antioxidant are optionally mixed with the respective components, and then each mixture is sufficiently stirred to reach a homogeneous state.

Then, a resulting product (i.e., the resulting homogenous mixture) is filtered through a filter to obtain the ink compositions Examples 1-7 and Comparative Examples 1-4.

In Table 2 and Table 3, an amount of each component listed in parentheses is based on 100 parts by weight of the respective ink composition, and the rest of the respective ink compositions is water.

TABLE 2

| | | | Media-philic | | Media-phobic | |
|---|---|---|---|---|---|---|
| Sample | Colorant (g) | | additive (g) | | additive (g) | |
| Example 1 | DB199 | 4 | 1,2-HD | 8 | — | — |
| Example 2 | AY23 | 4 | Surfynol 465 | 0.75 | — | — |
| | | | 2-cyclohexyl-2- | 17 | | |
| | | | pyrrolidone | | | |
| Example 3 | RR180 | 5 | Surfynol 465 | 0.8 | DEG | 20 |
| Example 4 | DBK168 | 4 | 1,2-HD | 7 | Polyoxyethylene | 0.5 |
| | | | 2-cyclohexyl-2- | 12 | sorbitan mono | |
| | | | pyrrolidone | | laurate | |
| Example 5 | CB | 5 | Surfynol 465 | 0.2 | 1,5-Pentanediol | 24 |
| Example 6 | Cabojet 200 | 4 | DEG-MBE | 4 | PEG 200 | 2 |
| | | | 1,2-HD | 2 | Glycerin | 2 |
| Example 7 | Phthalocyanine | 5 | 1,2-HD | 4 | 2-Pyrrolidone | 12 |
| | Blue | | | | | |
| Comp. Example 1 | DB199 | 4 | 2-cyclohexyl-2- | 0.08 | — | — |
| | | | pyrrolidone | | | |
| Comp. Example 2 | AY23 | 5 | TEG-MBE | 37 | — | — |
| Comp. Example 3 | RR180 | 5 | DEG-MBE | 22 | Ethriol | 0.12 |
| Comp. Example 4 | DBK168 | 4 | Surfynol 465 | 0.15 | EG | 15 |
| | | | | | 1,5-Pentanediol | 7 |
| Comp. Example 5 | CB | 4 | Surfynol 465 | 1.5 | 1,4-Butanediol | 0.08 |
| Comp. Example 6 | Cabojet 200 | 5 | DEG-MBE | 2 | DEG | 20 |
| | | | Surfynol 465 | 0.5 | 2-Pyrrolidone | 10 |

TABLE 3

| | | | Media-philic | | Media-phobic | |
|---|---|---|---|---|---|---|
| Sample | Colorant (g) | | additive (g) | | additive (g) | |
| Example 8 | DB199 | 5 | DEG | 10 | — | — |
| Example 9 | AY23 | 4 | PEG 200 | 2 | — | — |
| | | | Glycerin | 15 | | |
| Example 10 | RR180 | 4 | 1,4-BD | 10 | DEG-MBE | 1.5 |
| Example 11 | DBK168 | 5 | PEG 200 | 8 | 1,2-HD | 0.5 |
| | | | EG | 5 | | |
| Example 12 | CB | 5 | Polyoxyethylene | 0.1 | 2-cyclohexyl-2- | 0.6 |
| | | | sorbitan mono | | pyrrolidone | |
| | | | laurate | | DEG-MBE | 0.4 |
| Example 13 | Cabojet 200 | 4 | Glycerin | 2 | TEG-MBE | 2 |
| | | | Polyoxyethylene | 0.2 | 1,2-HD | 0.5 |
| | | | sorbitan mono | | | |
| | | | laurate | | | |
| Example 14 | Phthalocyanine | 5 | 1,5-PD | 5 | 2-cyclohexyl-2- | 2 |
| | Blue | | | | pyrrolidone | |
| Comp. Example 7 | DB199 | 4 | Polyoxyethylene | 0.05 | — | — |
| | | | sorbitan mono | | | |
| | | | laurate | | | |
| Comp. Example 8 | AY23 | 4 | Glycerin | 38 | — | — |
| Comp. Example 9 | RR180 | 5 | 1,5-PD | 10 | TEG-MBE | 0.08 |
| Comp. Example 10 | DBK168 | 4 | DEG | 1 | DEG-MBE | 7 |
| | | | | | 2-cyclohexyl-2- | 7 |
| | | | | | pyrrolidone | |
| Comp. Example 11 | CB | 5 | Glycerin | 4 | TEG-MBE- | 0.05 |
| Comp. Example 12 | Cabojet 200 | 5 | EG | 2 | 2-cyclohexyl-2- | 20 |
| | | | | | pyrrolidone | |
| | | | Ethriol | 2 | 1,2-HD | 8 |

### Experimental Example 1

### Storage Stability of Ink Composition Over Long Storage Period of Time

100 ml of the ink compositions prepared according to Examples 1-14 and Comparative Examples 1-12 were respectively placed into heat resistant vials, openings of the vials were closed, and the vials were stored in an incubator at 60° C. After 2 months, each vial was checked to determine whether precipitates were formed in the inks composition and to determine whether ink layers were separated at bottoms of the vials and whether viscosities thereof changed. The results are described in Table 4 below, according to the following criteria:
⊚: no precipitates, no layer separation, viscosity change within 5% of the initial value.
◯: no precipitates, no layer separation, viscosity change within 10% of the initial value.
Δ: no precipitates, layer separation occurred.
X: precipitates occurred.

### Experimental Example 2

### Initial Contact Angle

One droplet of each of the ink compositions prepared according to Examples 1-14 and Comparative Examples 1-12 was dropped on a medium using a 20 mL syringe having a gauge 22 needle, and 0.5 seconds after that, an angle formed at an interface between each droplet and the general paper was measured using a contact angle measuring equipment FTA 200 (First Ten Angstrom Company). The ink compositions of Examples 1-7 and Comparative Examples 1-6 were dropped on a Samsung general paper, and the ink compositions of Examples 8-14 and Comparative Examples 7-12 were dropped on a coating paper coated with 1 wax, and contact angles were measured. The results are described in Table 4 below, according to the following criteria:
Dye Inks (Examples 1-4 and 8-11 and Comparative Examples 1-4 and 7-10):
□: 30 to 40°.
◯: 25° to less than 30°, or higher than 40° to 45°.
Δ: 20° to less than 25°, or higher than 45° to 50°.
X: 20° or less, or higher than 50°.
Pigment Inks (Examples 5-7 and 12-14 and Comparative Examples 5, 6, 11, and 12):
⊚: 40 to 55°.
◯: 30° to less than 40°, or higher than 55° to 65°.
Δ: 25° to less than 30°, or higher than 65° to 70°.
X: 25° or less, or higher than 70°.

### Experimental Example 3

### Image Concentration (Optical Density)

Of the ink compositions obtained in Examples 1-14 and Comparative Examples 1-12, dye inks (Examples 1-4 and 8-11, and Comparative Examples 1-4 and 7-10) were refilled in an ink cartridge C-60 (Samsung Electronics Co., Ltd.), and pigment inks (Examples 5-7 and 12-14, and Comparative Examples 5, 6, 11, and 12) were refilled in an ink cartridge M-50 (Samsung Electronics Co., Ltd.). Then, immediately after a solid box (10*10 cm) was printed on Samsung general paper using a Samsung printer (MJC-3300p, Samsung Electronics Co., Ltd.), a color concentration of each solid box was measured using a measuring equipment GretagMacbeth D196. The ink compositions of Examples 1-7 and Comparative Examples 1-6 were dropped on a Samsung general paper, and the ink compositions of Examples 8-14 and Comparative Examples 7-12 were dropped on a coating paper coated with 1 wax, and optical densities were measured. The results are described in Table 4 below, according to the following criteria:
Dye Inks (Examples 1-4 and 8-11 and Comparative Examples 1-4 and 7-10):
□: 0.85 or higher.
◯: 0.75 or higher to less than 0.85.
Δ: 0.65 or higher to less than 0.75.
X: less than 0.60.
Pigment Inks (Examples 5-7 and 12-14 and Comparative Examples 5, 6, 11, and 12):
□: 1.15 or higher.
◯: 1.00 or higher to less than 1.15.
Δ: 0.80 or higher to less than 1.00.
X: less than 0.80.

### Experimental Example 4

### Evaluation for Back-smear

Of the ink compositions obtained in Examples 1-14 and Comparative Examples 1-12, the dye inks (Examples 1-4 and 8-11, and Comparative Examples 1-4 and 7-10) were refilled in an ink cartridge C-60 (Samsung Electronics Co., Ltd.), and the pigment inks (Examples 5-7 and 12-14, and Comparative Examples 5, 6, 11, and 12) were refilled in an ink cartridge M-50 (Samsung Electronics Co., Ltd.). The ink compositions of Examples 1-7 and Comparative Examples 1-6 were dropped on a Samsung general paper, and the ink compositions of Examples 8-14 and Comparative Examples 7-12 were dropped on a coating paper coated with 1 wax, and when printing continuously in full-coverage using a Samsung printer (MJC-3300p, Samsung Electronics Co., Ltd.), a degree of back smear on a next printed paper that occurs because the image of a previous paper is not dried was evaluated. The results are described in Table 4 below, according to the following criteria:
□: no back-smear occurred.
◯: little back-smear occurred.
X: back-smear occurred seriously.
XX: back-smear occurred very seriously.

### Experimental Example 5

### Evaluation for Bleeding Between Colors

Of the ink compositions obtained in Examples 1-14 and Comparative Examples 1-12, selected ones of the dye inks (Examples 1-4 and 8-11, and Comparative Examples 1-4 and 7-10) were refilled in an ink cartridge C-60 (Samsung Electronics Co., Ltd.), and selected ones of the pigment inks (Examples 5-7 and 12-14, and Comparative Examples 5, 6, 11, and 12) were refilled in an ink cartridge M-50 (Samsung Electronics Co., Ltd.). The ink compositions of Examples 1-7 and Comparative Examples 1-6 were dropped on a Samsung general paper, and the ink compositions of Examples 8-14 and Comparative Examples 7-12 were dropped on a coating paper coated with 1 wax, and when adjacent printing was performed using a Samsung printer (MJC-3300p, Samsung Electronics Co., Ltd.) and combinations of the selected dye and pigment inks as Ink Sets 1-4. A degree of bleeding between colors was evaluated. The results are described in Table 5 below, according to the following criteria:
⊚: little bleeding between colors occurred.
◯: some bleeding between colors occurred.
X: bleeding between colors occurred seriously.
XX: bleeding between colors occurred very seriously.

### Experimental Example 6

### Evaluation of Absorption Time

1 μL of one droplet of the ink compositions prepared according to Examples 1-14 and Comparative Examples 1-12 was dropped on a media using a 10 mL syringe having a gauge 27 needle, and the time until the ink was completely absorbed on the media was measured using measuring equipment FTA 200 (First Ten Angstrom Company). The ink compositions of Examples 1-7 and Comparative Examples 1-6 were dropped on a Samsung general paper, and the ink compositions of Examples 8-14 and Comparative Examples 7-12 were dropped on a coating paper coated with wax, and absorption times were measured. The results are described in Table 4 below, according to the following criteria:
⊚: absorption time 1 sec. or less.
◯: absorption time about 2 to about 3 sec.
X: absorption time about 4 to about 6 sec.
XX: absorption time about 7 sec. or higher.

### Experimental Example 7

### Evaluation of Nozzle Clogging

Of the ink compositions obtained in Examples 1-14 and Comparative Examples 1-12, the dye inks (Examples 1-4 and 8-11, and Comparative Examples 1-4 and 7-10) were refilled in an ink cartridge C-60 (Samsung Electronics Co., Ltd.), and the pigment inks (Examples 5-7 and 12-14, and Comparative Examples 5, 6, 11, and 12) were refilled in an ink cartridge M-50 (Samsung Electronics Co., Ltd.). Then, printing was performed after storing the ink cartridges for 2 weeks at ambient temperature (25° C.), and a number of times that nozzles of the printer were required to be cleaned to obtain normal printing was determined. The results are described in Table 4 below, according to the following criteria:
⊚: normal printing was possible after cleaning nozzles one time.
◯: normal printing was possible after cleaning nozzles 2 to 4 times.
X: normal printing was possible after cleaning nozzles 5 to 10 times.

XX: normal printing was not possible even after cleaning nozzles 11 times.

TABLE 4

| | Storage stability | | Image | | | |
|---|---|---|---|---|---|---|
| | over long period | Initial contact | concentration | Back- | Absorption | Nozzle |
| Sample | of ink | angle (°) | (Optical density) | smear | time | clogging |
| Example 1 | ⊚ | ◯ | ◯ | ⊚ | ⊚ | ◯ |
| Example 2 | ◯ | ⊚ | ⊚ | ⊚ | ⊚ | ⊚ |
| Example 3 | ⊚ | ◯ | ⊚ | ◯ | ⊚ | ⊚ |
| Example 4 | ◯ | ⊚ | ◯ | ⊚ | ⊚ | ⊚ |
| Example 5 | ⊚ | ⊚ | ⊚ | ◯ | ⊚ | ◯ |
| Example 6 | ⊚ | ⊚ | ◯ | ⊚ | ⊚ | ⊚ |
| Example 7 | ⊚ | ◯ | ⊚ | ⊚ | ⊚ | ⊚ |
| Example 8 | ◯ | ⊚ | ⊚ | ⊚ | ⊚ | ⊚ |
| Example 9 | ⊚ | ⊚ | ⊚ | ⊚ | ⊚ | ⊚ |
| Example 10 | ◯ | ◯ | ◯ | ⊚ | ⊚ | ⊚ |
| Example 11 | ⊚ | ◯ | ◯ | ⊚ | ⊚ | ⊚ |
| Example 12 | ⊚ | ⊚ | ⊚ | ◯ | ⊚ | ◯ |
| Example 13 | ◯ | ◯ | ◯ | ◯ | ⊚ | ◯ |
| Example 14 | ⊚ | ◯ | ⊚ | ⊚ | ⊚ | ⊚ |
| Comp. | ◯ | X | ⊚ | X X | X X | X X |
| Example 1 | | | | | | |
| Comp. | Δ | X | X | ⊚ | ⊚ | X |
| Example 2 | | | | | | |
| Comp. | Δ | X | X | ⊚ | ⊚ | ◯ |
| Example 3 | | | | | | |
| Comp. | ⊚ | X | ◯ | X X | X X | ⊚ |
| Example 4 | | | | | | |
| Comp. | ◯ | Δ | Δ | X | X | X |
| Example 5 | | | | | | |
| Comp. | ◯ | Δ | ◯ | X | X | ◯ |
| Example 6 | | | | | | |
| Comp. | ◯ | X | ⊚ | X X | X X | X X |
| Example 7 | | | | | | |
| Comp. | ◯ | X | X | ⊚ | ⊚ | X |
| Example 8 | | | | | | |
| Comp. | ⊚ | Δ | Δ | X | X | ◯ |
| Example 9 | | | | | | |
| Comp. | ◯ | X | ◯ | X X | X X | ◯ |
| Example 10 | | | | | | |
| Comp. | ⊚ | Δ | Δ | ◯ | ⊚ | X |
| Example 11 | | | | | | |
| Comp. | ◯ | X | ◯ | X X | X X | ◯ |
| Example 12 | | | | | | |

TABLE 5

| Sample | Ink | Evaluation results |
|---|---|---|
| Ink set 1 | Example 2 & Example 4 | ◯ |
| Ink set 2 | Example 3 & Example 6 | □ |
| Ink set 3 | Example 9 & Example 11 | ◯ |
| Ink set 4 | Example 13 & Example 14 | □ |
| Ink set 5 | Example 2 & Comp. Example 6 | X |
| Ink set 6 | Comp. Example 1 & Comp. Example 4 | X X |
| Ink set 7 | Example 9 & Comp. Example 12 | X |
| Ink set 8 | Comp. Example 7 & Comp. Example 10 | X X |

As apparent from Tables 4 and 5, the ink compositions of Examples 1 to 14 have excellent storage stability over a long period of time and a high color concentration (optical density), do not cause a back-smear even during continuous printing, do not cause bleeding between colors, and do not cause nozzle clogging even after storage for long periods.

On the other hand, when the amount of the media-philic additive was too high (Comparative Examples 2 and 8), the contact angle was so small that the ink composition was quickly dried, a back-smear did not occur, but the image concentration was too low. When the amount of the media-phobic additive was too high (Comparative Examples 4 and 10), or the amount of the media-philic additive was too low when the media-philic additive was used alone (Comparative Examples 1 and 7), the contact angle was so large that the image was too slowly dried, the color concentration was high, but a back-smear and bleeding between colors (Ink set 6 and Ink set 8) occurred. When the amount of the media-phobic additive was too high (Comparative Examples 6 and 12), even though the amount of the media-phobic additive was proper with respect to the media-philic additive, the ink composition was not quickly dried, and thus a back-smear and bleeding between colors (Ink set 5 and Ink set 7) occurred.

Inkjet ink compositions according to various embodiments of the present general inventive concept include a media-philic additive and a media-phobic additive in a suitable ratio according to a surface property of a printing medium and have an optimal compatibility with the surface property of the printing medium used in a high speed-and-quality printing system, thereby maintaining an absorption time of a dye ink and a pigment ink within 1 second, resulting in a high color concentration without affecting an image quality due to excessive penetration of the ink composition, and minimizing bleeding between colors to prevent a black-smear.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An inkjet ink composition to record on a hydrophilic printing medium, comprising:
a colorant;
water; and
a media-philic additive having an affinity to the hydrophilic printing medium,
wherein an amount of the media-philic additive is in a range of about 0.1 to about 35 parts by weight based on 100 parts by weight of the inkjet ink composition.

2. The inkjet ink composition of claim 1, further comprising:
a media-phobic additive having substantially no affinity to the hydrophilic printing medium, wherein an amount of the media-phobic additive is in a range of about 1 to about 12,500 parts by weight based on 100 parts by weight of the media-philic additive.

3. The inkjet ink composition of claim 1, further comprising:
a media-phobic additive having substantially no affinity to the hydrophilic printing medium, wherein the amount of the media-phobic additive is in a range of about 0.1 to about 25 parts by weight based on 100 parts by weight of the ink composition.

4. The inkjet ink composition of claim 1, wherein the hydrophilic media is a general paper including mainly pulp, a coating paper or photo paper coated with a water coating solution, a fiber coated with an aqueous coating solution or processed with a hydrophilic treatment, plastic, and metal media.

5. The inkjet ink composition of claim 2, wherein the media-phobic additive is at least one additive selected from the group consisting of ethylene glycol, diethylene glycol, polyethylene glycol, 1,4-butanediol, 1,5-hexanediol, ethriol, glycerine, succinimide, caprolactam, 2-pyrrolidone, polyethylene glycol sorbitan monolaurate, and BYK 181.

6. The inkjet ink composition of claim 1, wherein the media-philic additive is at least one additive selected from the group consisting of 1,2-hexanediol, diethylene glycol monobutyl ether, triethylene glycol monobutyl ether, 2-cyclohexyl-2-pyrrolidone, and Surfynol 465.

7. The inkjet ink composition of claim 1, wherein the colorant is a pigment, an initial contact angle of the inkjet ink composition with the hydrophilic printing medium is 30 to 65°, an absorption time of 1 μL of an ink droplet of the inkjet ink composition is less than or equal to 1 second, and an optical density of the inkjet ink composition is greater than or equal to 1.05.

8. The inkjet ink composition of claim 1, wherein the colorant is a dye, an initial contact angle of the inkjet ink composition with the hydrophilic printing medium is 25 to 45°, an absorption time of 1 μL of an ink droplet of the inkjet ink composition is less than or equal to 1 second, and an optical density of the inkjet ink composition is greater than or equal to 0.8.

9. An inkjet ink composition to record on a hydrophobic printing medium, comprising:
a colorant;
water; and
a media-philic additive having an affinity to the hydrophobic printing medium, wherein an amount of the media-philic additive is in a range of about 0.1 to about 35 parts by weight based on 100 parts by weight of the ink composition.

10. The inkjet ink composition of claim 9, further comprising:
a media-phobic additive having substantially no affinity to the hydrophobic medium, wherein the amount of the media-phobic additive is in a range of about 1 to about 12,500 parts by weight based on 1000 parts by weight of the media-philic additive.

11. The ink composition of claim 9, wherein an amount of the media-phobic additive is in a range of about 0.1 to about 25 parts by weight based on 100 parts by weight of the ink composition.

12. The ink composition of claim 9, wherein the hydrophobic printing medium is a substrate made of glass or silicon, a coating paper or photo paper coated with a coating solution composed of oil or wax and a hydrophobic organic solvent, or processed with a hydrophobic treatment, textile, plastic, and metal media.

13. The inkjet ink composition of claim 9, wherein the media-phobic additive is at least one additive selected from the group consisting of 1,2-hexanediol, diethylene glycol monobutyl ether, 2-cyclohexyl-2-pyrrolidone, and Surfynol 465.

14. The inkjet ink composition of claim 9, wherein the media-philic additive is at least one additive selected from the group consisting of ethylene glycol, diethylene glycol, triethylene glycol monobutyl ether, polyethylene glycol, 1,4-butanediol, 1,5-hexanediol, ethriol, glycerine, succinimide, caprolactam, 2-pyrrolidone, polyethylene glycol sorbitan monolaurate, and BYK 181.

15. The inkjet ink composition of claim 9, wherein the colorant is a pigment, an initial contact angle of the inkjet ink composition with the hydrophobic printing medium is 30 to 65°, an absorption time of 1 μL of an ink droplet of the inkjet ink composition is less than or equal to 1 second, and an optical density of the inkjet ink composition is greater than or equal to 1.05.

16. The inkjet ink composition of claim 9, wherein the colorant is a dye, an initial contact angle of the inkjet ink composition with the hydrophobic printing medium is 25 to 45°, an absorption time of 1 μL of an ink droplet of the inkjet ink composition is less than or equal to 1 second, and an optical density of the inkjet ink composition is greater than or equal to 0.8.

17. An inkjet cartridge including an inkjet ink composition to record on a hydrophilic printing medium, the inkjet ink composition comprising:
a colorant;
water; and
a media-philic additive having an affinity to the hydrophilic printing medium,
wherein an amount of the media-philic additive is in a range of about 0.1 to about 35 parts by weight based on 100 parts by weight of the colorant.

18. An inkjet recording apparatus, comprising the inkjet cartridge of claim 17.

19. An inkjet cartridge including and an inkjet ink composition to record on a hydrophobic printing medium, the inkjet ink composition comprising:
a colorant;
water; and
a media-philic additive having an affinity to the hydrophobic medium, wherein an amount of the media-philic additive is in a range of about 0.1 to about 35 parts by weight based on 100 parts by weight of the colorant.

20. An inkjet recording apparatus, comprising the inkjet cartridge of claim 19.
